(19) United States
(12) Patent Application Publication
(10) Pub. No.: US 2006/0239732 A1
(43) Pub. Date: Oct. 26, 2006

(54) Image forming apparatus

(76) Inventors: Tetsu Sekine, Tokyo (JP); Akihiko Shimazu, Tokyo (JP); Yujiro Ishida, Sagamihara-shi (JP)

Correspondence Address: CANTOR COLBURN, LLP, 55 GRIFFIN ROAD SOUTH, BLOOMFIELD, CT, 06002, US

(21) Appl. No.: 11/338,931

(22) Filed: Jan. 25, 2006

(30) Foreign Application Priority Data
Apr. 26, 2005 (JP) JP2005-127663

(51) Int. Cl. G03G 15/00

(52) U.S. Cl. 399/394

(57) ABSTRACT

An image forming apparatus, including an image carrier, an image forming section for forming toner image on the image carrier, an image transfer device for transferring the toner images from the image carrier to a transfer material, and a registration member for conveying the transfer material to a position where the image transfer device transfers the toner image in synchronization with the image formation conducted by the image forming section, wherein the registration member includes a drive roller having a core and a rubber layer formed on the core, and a driven roller coming into contact with the drive roller, wherein the drive roller satisfies formula (1), d/D≦57.6 L^{-1.2}, and formula (2), d÷0.5, where D is diameter of the drive roller, d is thickness of the rubber layer, and L is conveyance distance from the registration member to the image transferring position.

This application is based on Japanese Patent Application No. 2005-127663 filed with the Japanese Patent Office, the entire content of which is hereby incorporated by reference.

### BACKGROUND OF THE INVENTION

The present invention relates to improvement of a registration member in an image forming apparatus which forms an image using electro-photographic process, that is, to improvement of a conveyance device which-conveys a transfer material, synchronizing the conveyance with image formation.

In recent years, an image forming apparatus, which forms the image by the electro-photographic process, has been used in the field of printing such as POD (print on demand), accordingly a technology for printing the image on a transfer material at a high positioning accuracy has been strongly required in the market.

In the image forming apparatus which forms the image by the electro-photographic process, toner images are formed on an image carrier, then the toner images on the image carrier are transferred onto the transfer material, and thereby final images are generated on the transfer material. During the above process, concerning the conveyance direction, the image position on the transfer material depends upon an operational accuracy of the registration member which conveys the transfer material in synchronization with the image formation on the image carrier, and in particular depends on the starting time and the conveyance rate of the transfer material, conducted by the registration member.

However, due to changes of temperature in the image forming apparatus, the thermal expansion of the registration member causes changes of conveyance rate of the transfer material, which results in positional deviation in the image. Particularly in the case of two-sided image formation, there has been a problem in that the image position of the front surface differs from that of the reverse surface. In the image forming apparatus which forms the image by the electro-photographic process, one method employs the intermediate transfer device through which the images are transferred from an image forming section to the transfer material, while the other method directly transfers the images from the image forming section to the transfer material. The above mentioned positional deviation of the images has occurred in both methods.

To this problem, Patent Document 1 proposes that the temperature of a drive roller, structured in a registration member, is detected, and the rotation rate of the drive roller is controlled based on the detected temperature.

[Patent Document 1] Japanese Non-examined Patent Publication No. 2000-44083

However, according to Patent Document 1, structure of the apparatus and its control are very complicated, and has less reliability as well as higher production cost.

### SUMMARY OF THE INVENTION

The present invention will now be described below.

Item 1. An image forming apparatus, including, an image carrier, an image forming section for forming toner images on the image carrier, an image transfer device for transferring the toner image from the image carrier to a transfer material, and a registration member for conveying the transfer material to a position where the image transfer device transfers the toner image in synchronization with the image formation conducted by the image forming section, wherein the registration member includes a drive roller having a core and a rubber layer formed on the core, and a driven roller coming into contact with the drive roller, wherein the drive roller satisfies formulas (1) and (2),
d/D≦57.6 L^{-1.2} Formula (1)
d≧0.5 Formula (2)

where,
D: diameter of the drive roller,
d: thickness of the rubber layer,
L: conveyance distance from the registration member to the position where the image transfer section transfers the toner image.

Item 2. The image forming apparatus described in Item 1, wherein the drive roller satisfies formula (3),
d/D≦103.9 L^{-1.5} Formula (3)

Item 3. The image forming apparatus described in Item 1, further including a sheet re-supplying section which turns over the transfer material carrying the image formed on one side, and then supplies the transfer material, showing the reverse surface, to the registration member.

Item 4. The image forming apparatus described in Item 1, wherein the image carrier is a photosensitive device on which image is exposed by an exposure device.

Item 5. The image forming apparatus described in Item 1, wherein the image carrier is an intermediate transfer device on which the toner image on the photosensitive device are transferred.

Item 6. The image forming apparatus described in Item 1, wherein the driven roller is structured of a rigid body.

### BRIEF DESCRIPTION OF THE DRAWINGS

FIG. 1 is a cross section of a color image forming apparatus, being an example of the embodiments of the image forming apparatus related to the present invention.

FIG. 2 shows a conveyance path from an intermediate transfer rollers to a transfer position via a registration member.

FIG. 3 is an operational timing chart of an exposure device and the registration member.

FIG. 4 shows a transfer sheet on which the images are printed.

FIG. 5 shows the structure of the registration member.

FIG. 6 shows the transfer sheet on both surfaces of which the images were printed.

FIG. 7 is a graph showing the experimental results.

FIG. 8 shows another example of the image forming apparatus related to the embodiment of the present invention.

### DETAILED DESCRIPTION OF THE PREFERRED EMBODIMENTS

The embodiments of this invention will be detailed below, however, the present invention is not limited to the present embodiments.

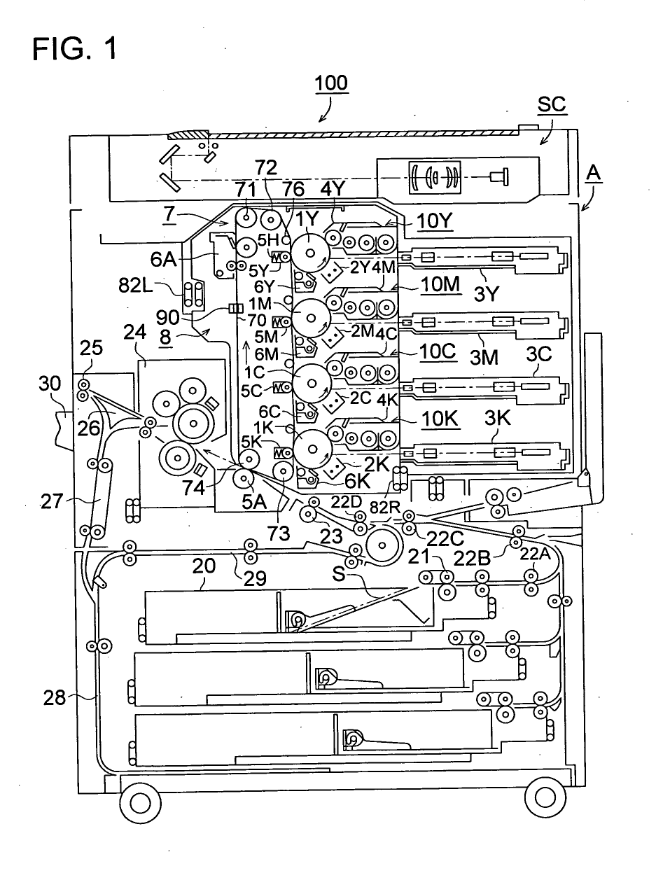

FIG. 1 is a cross sectional view of a color image forming apparatus as an example of the embodiment related to the present invention.

Color image forming apparatus 100, referred to as a tandem type color image forming apparatus, includes image forming sections 10Y, 10M, 10C and 10K as the image forming devices, intermediate transfer device unit 7, sheet supply and conveyance device 21, and fixing device 24.

Original document reading device SC is mounted on an upper section of main section A of the image forming apparatus.

Image forming section 10Y, to form yellow toner images, includes charging device 2Y, exposure device 3Y, developing device 4Y, first transfer roller 5Y and cleaning device 6Y, all of which are arranged around drum-shaped photo-conductor 1Y.

Image forming section 10M, to form magenta toner images, includes charging device 2M, exposure device 3M, developing device 4M, first transfer roller 5M and cleaning device 6M, all of which are arranged around drum-shaped photo-conductor 1M.

Image forming section 10C, to form cyan toner images, includes charging device 2C, exposure device 3C, developing device 4C, first transfer roller 5C and cleaning device 6C, all of which are arranged around drum-shaped photo-conductor 1C.

Image forming section 10K, to form black toner images, includes charging device 2K, exposure device 3K, developing device 4K, first transfer roller 5K and cleaning device 6K, all of which are arranged around drum-shaped photo-conductor 1K.

Intermediate transfer device unit 7 is structured of intermediate transfer device 70, being an endless belt which rotates as shown with an arrow in FIG. 1, and rollers 71, 72, 73 and 74. Intermediate transfer device 70 is an image carrier for carrying toner images which are to be transferred onto transfer material S. Image forming sections 10Y, 10M, 10C and 10K are image forming devices for forming toner images onto intermediate transfer device 70.

Unicolor toner images, each formed by image forming sections 10Y, 10M, 10C and 10K are sequentially transferred and overlapped onto rotating intermediate transfer device 70 by transfer rollers 5Y, 5M, 5C and 5K, and thereby multicolored toner image is created. Transfer material S, such as recording sheets, stored in sheet supplying cassette 20, are supplied by sheet supplying rollers 21, and passes through intermediate conveyance rollers 22A, 22B, 22C and 22D, and registration member 23, after which transfer material S is conveyed to secondary transfer roller 5A, serving as a transfer device, and multicolored toner image is together transferred onto transfer material S. Transfer material S, carrying the multicolored toner image is fixed by fixing device 24, and then transfer material S is nipped and exhausted to tray 30 by exhausting rollers 25.

After the multicolored toner image is transferred onto transfer material S by secondary transfer roller 5A, transfer material S is separated from intermediate transfer device 70, and remaining toner is removed from intermediate transfer device 70 by cleaning device 6A.

During the image forming process, first transfer roller 5K always presses intermediate transfer device 70 toward photo-conductor 1K, but the other first transfer rollers 5Y, 5M and 5C press intermediate transfer device 70 toward photo-conductors 1Y, 1M and 1C, respectively, only when color image is being formed. Secondary transfer roller 5A comes into pressure contact with intermediate transfer device 70, when the secondary transfer is conducted onto transfer material S.

Biased voltage, applied to first transfer rollers 5Y, 5M, 5C and 5K, as well as biased voltage, applied to secondary transfer roller 5A, is monitored by a control section, which is not illustrated, and the conditions of the first and secondary transfer rollers are varied based on the monitored voltages so that the adequate transfer conditions are maintained.

Volume resistivity of intermediate transfer device 70 is preferably 1×10⁷-1×10¹¹ Ω·cm, which can accomplish a stable image formation. Backup roller 74 is in pressure contact with secondary transfer roller 5A through intermediate transfer device 70. Each roller has a semi-conductive rubber surface, which is coated on a metallic shaft. For backup roller 74, a semi-conductive rubber material having the volume resistivity of 1×10⁵-1×10¹⁰ Ω·cm is preferably used, while for secondary transfer roller 5A, a semi-conductive rubber material having the volume resistivity of 1×10⁵-1×10¹⁰ Ω·cm is preferably used.

Transfer materials S, stored in sheet supplying tray 20, are picked up one by one by paired sheet supplying rollers 21, then each sheet S is conveyed by paired intermediate conveyance rollers 22A-22C to be nipped by registration member 23.

In order to transfer the images, carried on intermediate transfer device 70, onto a predetermined position on transfer material S, registration member 23 works in synchronization with image formation, and conveys transfer material S to a transfer position where image transferring is conducted by secondary transfer roller 5A. Numeral 26 represents a changeover gate to change conveyance paths, through one of which transfer material S is directly conveyed from fixing device 24 to sheet ejection roller 25, and through the other of which transfer material S is downwardly conveyed toward reversible conveyance section 27.

Numeral 28 represents a reversing section to reverse transfer material S to enable formation of images on the reverse surface, numeral 29 represents a sheet re-supplying section to supply sheet S again for a reverse surface image formation.

Transfer material S, ejected from fixing device 24, is further ejected onto tray 30 by paired ejection rollers 25, or conveyed to reversible conveyance section 27.

When transfer material S is to be flipped over and then ejected, firstly transfer material S is conveyed downward by reversible conveyance section 27, next transfer material S is switched back and conveyed upward by reversible conveyance section 27, after which transfer material S is ejected to tray 30 via paired ejection rollers 25.

When the images are to be formed on both sides of transfer material S, firstly transfer material S is conveyed downward by reversible conveyance section 27, next transfer material S is switched back to be flipped over, then conveyed to sheet re-supplying section 29, being a sheet re-supplying device, after which transfer material S is supplied to registration members 23 from sheet re-supplying section 29.

Then transfer material S is conveyed from registration member 23 to the transfer position where secondary transfer roller 5A functions, where the toner images are transferred onto the reverse surface of transfer material S, and after fixing process is conducted for the images by fixing device 24, transfer material S is ejected onto tray 30 by paired ejection rollers 25.

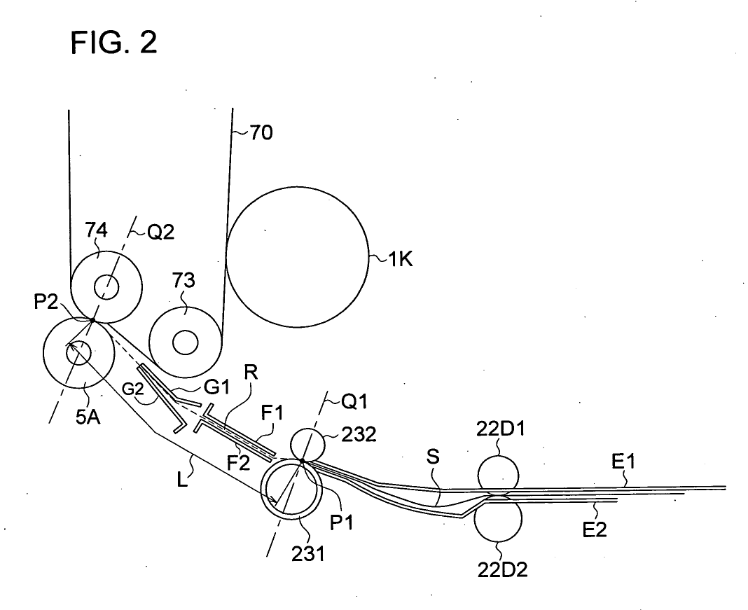

FIG. 2 shows conveyance path R from intermediate conveyance rollers 22D (22 D1 and 22D2) to transfer position P2 via registration members 23 (rollers 231 and 232).

Intermediate conveyance roller 22D includes paired drive rollers 22D1 and 22D2, while registration member 23 includes drive roller 231 and driven roller 232. Drive roller 231 is structured of a core made of a rigid body, such as stainless steel, and a rubber layer made of a rubber, such as an ethylene propylene rubber, formed on the core. Driven roller 232 is formed of a rigid body such as stainless steel. A conveyance section located between intermediate conveyance roller 22D and registration member 23 is formed of paired guide plates E1 and E2.

Conveyance path R, located between registration member 23 and transfer position P2, is formed of paired guide plates F1 and F2, as well as paired guide plates G1 and G2.

A part of conveyance path R, which is adjacent to transfer position P2, is formed of intermediate transfer device 70.

Transfer material S is supplied to registration member 23 by intermediate conveyance rollers 22D, and temporarily stopped by registration member 23. During the temporary stop, transfer material S is looped in a wide section between guide plates E1 and E2, where transfer material S is postured so that the top of transfer material S becomes perpendicular to the conveyance direction.

After the temporary stop, registration member 23 is activated to convey transfer material S toward transfer position P2.

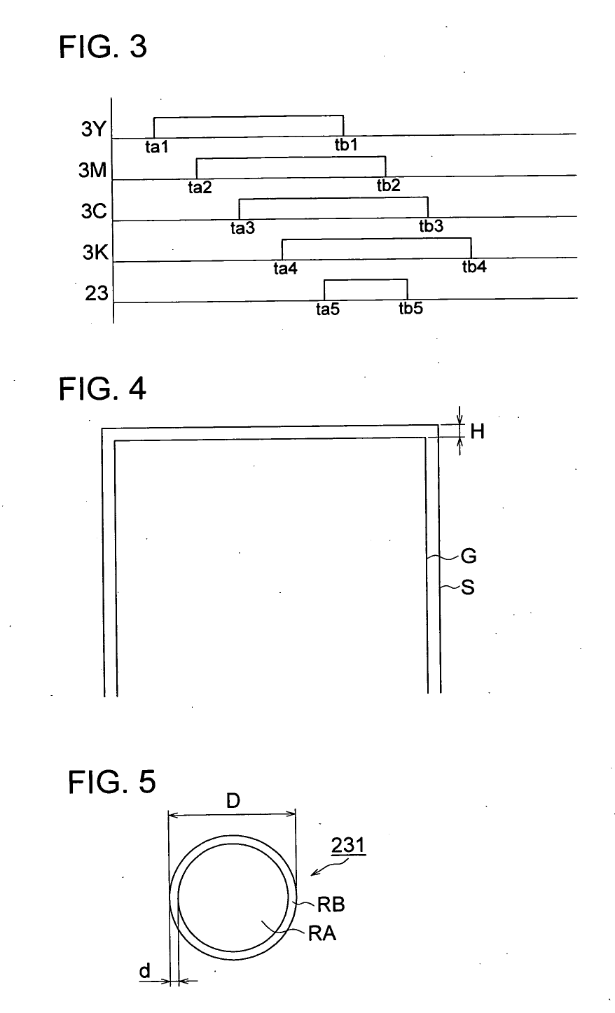

As shown in FIG. 3, registration member 23 is operated in the timing related to exposure devices 3Y, 3M, 3C and 3K.

FIG. 3 shows the operating timing charts of exposure devices 3Y, 3M, 3C and 3K, and registration member 23.

Exposure device 3Y starts operation at time ta1, and stops at time tb1, forming images on a photo-conductor 1Y. In the same manner, exposure device 3M starts operation at time ta2, and stops at time tb2, exposure device 3C starts operation at time ta3, and stops at time tb3, and exposure device 3K starts operation at time ta4, and stops at time tb4.

Registration member 23 starts operation at time ta5, and stops at time tb5. In addition, after registration member 23 stops at time tb5, a one way clutch, connected to registration member 23, is deactivated, enabling registration member 23 to rotate freely following transfer material S.

Based on the above-described timing control, image G, having peripheral areas of a predetermined width, is formed on transfer material S.

Times ta1, ta2, ta3 and ta4 are determined by calculation based on the travel rate of intermediate transfer device 70 and distances among exposure devices 3Y, 3M, 3C and 3K.

On the other hand, time ta5 is determined by calculation based on the distance between an exposure position of exposure device 3Y and transfer position P2, the travel rate of intermediate transfer device 70, the distance between position P1 of registration member 23 and transfer position P2, and the travel rate of transfer material S.

Among the parameters used for the determination of times ta1-ta5, the travel rate of transfer material S is determined by the conveyance rate of registration member 23, however, the conveyance rate of registration member 23 varies depending upon temperature.

Drive roller 231 of registration member 23, shown in FIG. 5, is structured of core RA formed of a stainless steel core which is covered with rubber layer RB. Coefficient of thermal expansion of rubber layer RB is so great that diameter D of drive roller 231 can vary by temperature change, which results in the change of the conveyance rate of drive roller 231, whereby time ta5 in FIG. 3 changes due to changes in temperature.

If the image forming apparatus is controlled excluding a countermeasure of the change of time ta5, generated is the change of clearance H at the top of transfer material S, shown in FIG. 4.

The inventor of the present invention experimented the deviation of the top position of the image formed on transfer material S, to see how deviation was affected by diameter D of drive roller 231 of registration member 23, thickness “d” of rubber layer RB, and conveyance distance L between position P1 of registration member 231 and transfer position P2.

In FIG. 2, position P1 of registration member 23 is a point where line Q1, joining the centers of rotation of drive roller 231 and the center of rotation of driven roller 232, intersects with conveyance path R. Next, transfer position P2 is a point where line Q2, joining the center of rotation of transfer roller 5A and the center of rotation of backup roller 74, intersects with conveyance path R. Conveyance distance L between position P1 of registration member 231 and transfer position P2 is the length of conveyance path R in which transfer material S runs through guide plates F1 and F2, and G1 and G2, as shown by a dashed line.

The inventor studied by the experiment that after image formation started during continuous image formation, the temperature of the area adjacent to registration member 23 increased, and when the temperature became greater by 20° C. than the starting temperature, the temperature came to equilibrium.

The positional deviation of the images, printed on the front page and the reverse page, is actually disadvantageous.

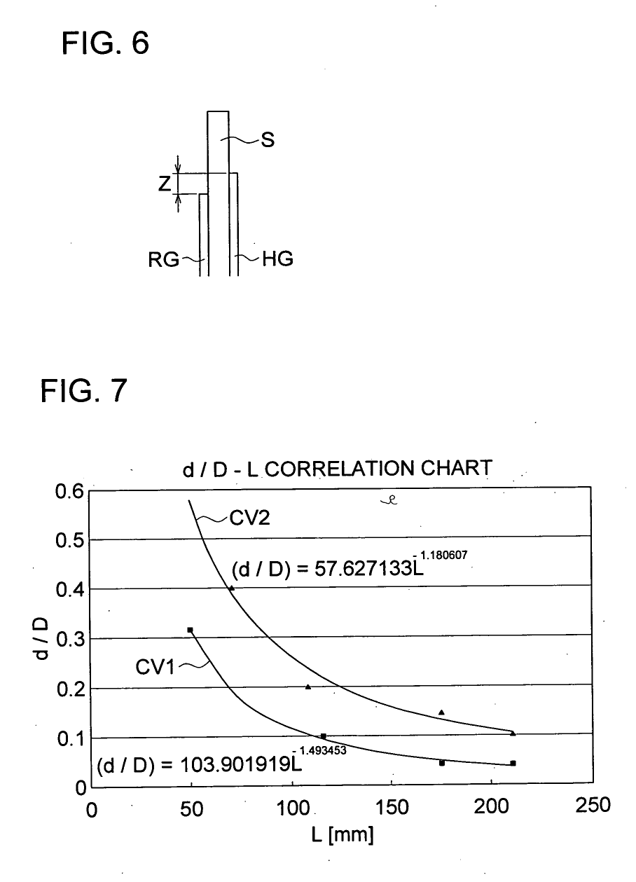

In FIG. 6, deviation Z was studied in such a way that with allowable value of 1.4 mm for deviation Z, generated between the top positions of the front image HG and the reverse page image RG, while parameters D, d and L were changed, the temperature of the area adjacent to registration member 23 was also changed during continuous image formation. In addition, the allowable value is not visually detectable by human eyes.

FIG. 7 and Table 1 show the experimental results.

TABLE 1

| | L [mm] | | | | | |
|---|---|---|---|---|---|---|
| | | 50 | 70 | 110 | 170 | 210 |
| d/D | 0.02 | | r.D | r.D | r.D | r.D |
| | 0.04 | | | | r.A | r.A |
| | 0.10 | | | r.A | | r.B |
| | 0.15 | | | | r.B | r.C |
| | 0.20 | | | r.B | r.C | |
| | 0.30 | r.A | | | | |
| | 0.40 | | r.B | r.C | | |

In FIG. 7, curve CV1 is plotted with points which barely deviate with the best results, while Curve CV2 is plotted with points which satisfy the allowable value of 1.4 mm, however with some amount of deviation.

Curve CV1 is shown by the following formula:
d/D=103.901919L^{-1.493453}

The approximate formula of curve CV1 is:
d/D=103.9L^{-1.5} (1)

Curve CV2 is shown by the following formula:
d/D=57.627133L^{-1.180607}

The approximate formula of curve CV2 is:
d/D=57.6L^{-1.2} (2)

Previous Table 1 shows the experimental results based on the fundamental data of curves CV1 and CV2 in FIG. 7. In Table 1, “r.A” means the best results, while “r.B” means better results satisfying the allowable value of 1.4 mm, and “r.C” shows unacceptable results in which deviation is beyond the allowable value. The thickness of rubber layer to exhibit reasonable durability must be greater than or equal to 0.5 mm.

“r.D” in Table 1 represents unacceptable results for durability due to a thinner rubber layer.

By the above experiment, the registration member which does not change due to temperature at time ta5 can be obtained, whereby correction control based on temperature at time ta5 is not necessary, and images can be formed on transfer material S with higher positional accuracy.

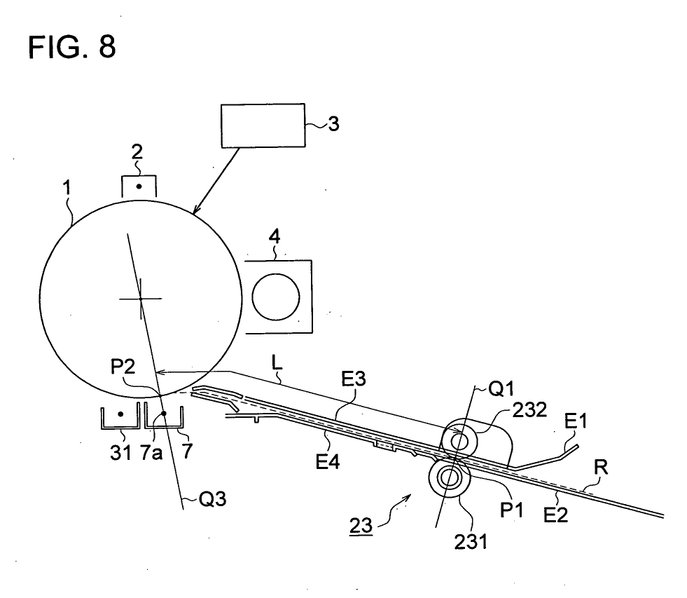

FIG. 8 shows the relevant parts of another example of the embodiments of the present invention.

In FIG. 8, numeral 1 represents a drum-shaped photosensitive device as the image carrier, numeral 2 represents a charging device structured of a corona charging device, numeral 4 represents a developing device, numeral 7 represents a transfer device structured of a corona charging device, numeral 31 represents a separating device structured of a corona charging device, symbols E1-E4 represent guide plates to guide transfer material P, and numeral 23 represents a registration member.

Electrostatic latent images are generated on photosensitive device 1 by the charging operation of charging device 2 and the exposure operation of exposure device 3, then the electrostatic latent images are developed by developing device 4, whereby toner images are formed. In this manner, an image forming section is structured of charging device 2, exposure device 3 and developing device 4.

Transfer material S is guided by guide plates E1-E4, conveyed by registration member 23, and passes through transfer position P2, then the toner images, formed on photosensitive device 1, are transferred onto transfer material S by transfer device 7. Transfer material S, carrying the toner images, is separated from photosensitive device 1 by separating device 31, and is conveyed to a fixing device, which is not illustrated, where the image is fixed.

In this embodiment, registration member 23 includes drive roller 231 and driven roller 232. Drive roller 231 is structured of a core made of a rigid body such as stainless steel, and a rubber layer formed on the core. A transfer section can be structured in such a way that formulas (1) and (2) can be established among diameter D of drive roller 231, thickness d of the rubber layer, and conveyance distance L between position P1 of registration member 23 and transfer position P2, whereby an image forming apparatus having less deviation of the top position of the images can be structured.

Additionally, in the present example, transfer position P2 being an end point of conveyance distance L is a point where straight line Q3, joining the center of rotation of photosensitive device 1 and charging electrode 7a of transfer device 7, intersects with conveyance path R for transfer material S.

Position P1 of registration member 23, to form another end point of conveyance distance L, is a point where line Q1, joining the center of rotation of drive roller 231 and the center of rotation of driven roller 232, intersects with conveyance path R, the same as the first example.

According to the present embodiments, this image forming apparatus enables the leading edge of the image to more accurately position on the transfer material, and further the images can be formed at lower production cost with higher accuracy as in the case of off-set printing.

Furthermore, by satisfying formula (3)
d/D≦103.9L^{-1.5} (3)

an image forming apparatus enables higher positional accuracy of printed images.

Moreover, in double sided image formation of the preset embodiments, effectively prevented is the problem in which the position of an image on the front side differs from that of the reverse surface

What is claimed is:

1. An image forming apparatus, comprising:
an image carrier;
an image forming section for forming toner image on the image carrier;
an image transfer device for transferring the toner images from the image carrier to a transfer material; and
a registration member for conveying the transfer material to a position where the image transfer device transfers the toner image in synchronization with the image formation conducted by the image forming section;
wherein the registration member includes a drive roller having a core and a rubber layer formed on the core; and
a driven roller coming into contact with the drive roller;
wherein the drive roller satisfies formulas (1) and (2),
d/D≦57.6 L^{-1.2} formula (1)
d≧0.5 formula (2)
where,
D: diameter of the drive roller,
d: thickness of the rubber layer, and
L: conveyance distance from the registration member to the position where the image transfer device transfers the toner image.

2. The image forming apparatus in claim 1, wherein the drive roller satisfies formula (3),
d/D≦103.9L^{-1.5} formula (3)

3. The image forming apparatus in claim 1, further comprising a sheet re-supplying section which turns over the transfer material carrying the image formed on one side, and then supplies the transfer material with the reverse surface, to the registration member.

4. The image forming apparatus in claim 1, wherein the image carrier is a photosensitive device on which image is exposed by an exposure device.

5. The image forming apparatus in claim 1, wherein the image carrier is an intermediate transfer device on which the toner image on the photosensitive device is transferred.

6. The image forming apparatus in claim 1, wherein the driven roller is structured of a rigid body.
